(19) United States
(12) Patent Application Publication
(10) Pub. No.: US 2025/0367838 A1
(43) Pub. Date: Dec. 4, 2025

(54) Biodegradable Hydrogel Actuator with Shape Morphing Capability for Soft Robotics and Methods of Fabrication

(71) Applicant: Carnegie Mellon University, Pittsburgh, PA (US)

(72) Inventors: Victoria Webster-Wood, PIttsburgh, PA (US); Wenhuan Sun, PIttsburgh, PA (US); Adam Walter Feinberg, PIttsburgh, PA (US); Lining Yao, Berkeley, CA (US); Carmel Majidi, PIttsburgh, PA (US); Avery Williamson, Pittsburgh, PA (US)

(73) Assignee: Carnegie Mellon University, Pittsburgh, PA (US)

(21) Appl. No.: 18/876,290

(22) PCT Filed: Apr. 30, 2023
(86) PCT No.: PCT/US2023/020512

§ 371 Date: Dec. 18, 2024

Related U.S. Application Data
(60) Provisional application No. 63/357,283, filed on Jun. 30, 2022.

(51) Int. Cl. B25J 19/00; B25J 9/14; C08J 3/075; C08J 3/24

(52) U.S. Cl. CPC B25J 19/007; B25J 9/142; C08J 3/075; C08J 3/244; C08J 2305/04

(57) ABSTRACT

A morphing, biologically-derived actuator can be used with soft robotics in a marine environment. The actuator is fabricated using a modified hydrogel additive manufacturing printing process, where the printed structure is exposed to various concentrations of crosslinking initiator to ensure a water-tight seal between adjacent printed layers. The actuator fabricated using the disclosed process is suitable for marine use and is safe for marine animals and is biodegradable.

### CROSS-REFERENCE TO RELATED APPLICATIONS

This application claims the benefit under 35 U.S.C. § 119 of U.S. Provisional Application Ser. No. 63/357,283, filed on Jun. 30, 2022, which is incorporated herein by reference.

### STATEMENT REGARDING FEDERALLY SPONSORED RESEARCH

This invention was made with United States government support under 2015317 and 2044785 awarded by the National Science Foundation. The U.S. government has certain rights in the invention.

### BACKGROUND OF THE INVENTION

The present disclosure generally relates to an actuator for soft robotics. More specifically, the disclosure relates to a morphing actuator fabricated from biocompatible materials and capable of being use in marine environments.

Soft robotics involves the use of robots with compliant structures created from soft materials, allowing the robots to interact safely with living organisms. Recent material science and manufacturing advances have enabled significant progress in soft actuation using unconventional building materials. Despite the impressive performance of these robots, many of their components are non-biodegradable or even toxic and may negatively impact sensitive ecosystems. To overcome these limitations, biologically-sourced hydrogels have been explored as a candidate material for marine robotics.

While a promising material, fabricating structures from hydrogels can be challenging because hydrogels are too soft to support their weight during printing. To overcome this limitation, embedded printing can be used, where hydrogels are extruded into a fugitive support bath. Yet, challenges remain with this process in creating actuators suitable for a marine environment, where such actuators must: (1) be water-tight, (2) exhibit repeatable and reliable motion and force, and (3) enable additional design freedom over traditional fabrication approaches. It would therefore be advantageous to develop soft robotic actuators for the realization of morphing, adaptable robotic manipulation systems that can be fabricated at scale and be deployed en masse in ocean environments with minimal environmental impact.

### BRIEF SUMMARY

According to embodiments of the present disclosure is a soft robotic actuator for use in marine environments. The small-scale biologically-derived actuator comprises a thin-wall structure that is water-tight and capable of being internally pressurized for hydraulic or pneumatic actuation. In one embodiment, the actuators are fabricated in a 3D printing process from calcium-alginate hydrogels, a sustainable biomaterial sourced from brown seaweed. Furthermore, the actuators are biodegradable, safely edible, and digestible by marine organisms. A reversible chelation-crosslinking mechanism can be used to dynamically modify the alginate actuators' structural stiffness and morphology. These capabilities will allow researchers to design and manufacture soft robots that can be safely deployed in aquatic environments, interact with delicate plants and animals, and safely degrade following mission completion.

### BRIEF DESCRIPTION OF THE SEVERAL VIEWS OF THE DRAWINGS

FIGS. 1A-1C depict actuators fabricated according to one embodiment.

FIG. 2 is an actuator according to an alternative embodiment, where the linear motion of the actuator is shown.

FIG. 3 is a graph showing linear motion of an actuator over time.

FIG. 4 is the force exerted by an actuator over time for around 100 cycles.

FIG. 5 is an actuator according to an alternative embodiment.

FIG. 6 is an actuator according to yet another alternative embodiment.

FIG. 7A-7B are schematics of a fabrication process according to one embodiment.

FIG. 8 is a cross-sectional view of an actuator.

FIG. 9 is an actuator according to an alternative embodiment.

FIG. 10 is a graph depicting the morphing abilities of an actuator in response to chelation and crosslinking.

FIG. 11 is an actuator with an internal channel.

### DETAILED DESCRIPTION

According to embodiments of the disclosure is an actuator 100 with tunable mechanical properties and morphing capabilities for use in soft robotic applications. The actuator 100 comprises a biologically derived material, such as alginate sourced from Lessonia nigrescens and Lessonia trabeculata, two brown seaweed species. The adaptable, compliant, and biocompatible actuator 100 may be used in soft robotic systems for manipulation and locomotion in marine environments. By adjusting the level of crosslinking, the actuator 100 provides soft robotics with the ability to dynamically tune material properties and adjust both their mechanical strength and their physical geometry post-fabrication to a target application.

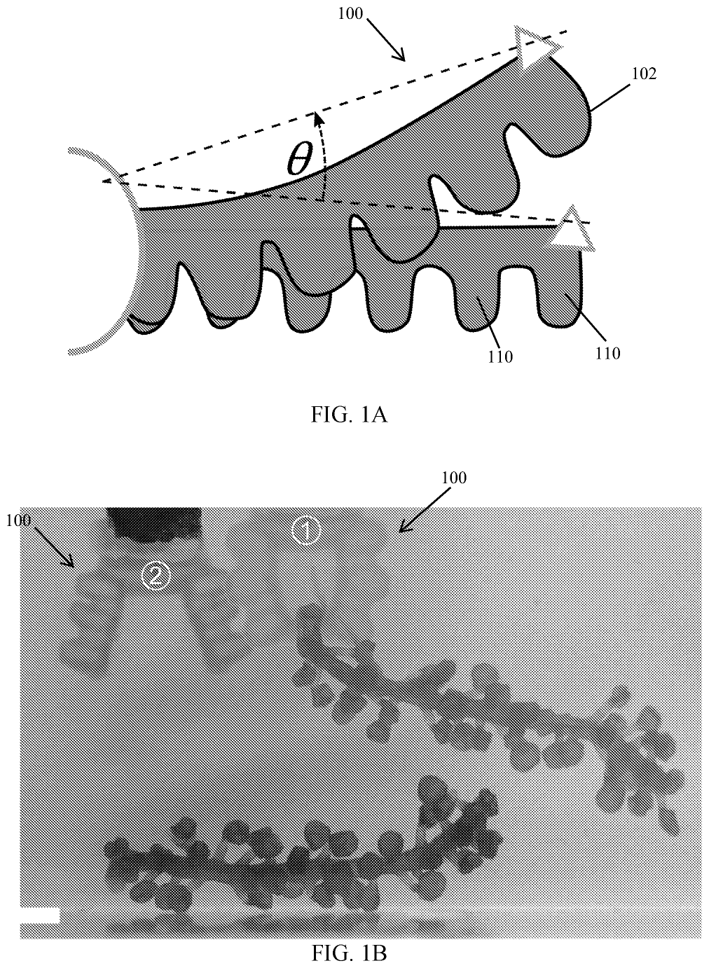

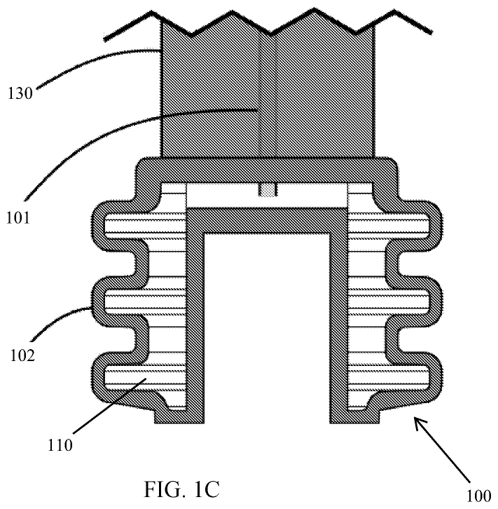

FIG. 1A shows an example of a pneumatic network (PneuNet) type of actuator 100 formed by the hydrogel printing process, according to one embodiment. The PneuNet actuator 100 is a style of soft actuator with a series of internal cavities 110 that are pressurized or depressurized to induce movement. Shown in FIG. 1A is the actuator 100 in a default and ‘actuated’ state, with the range of motion between the two stated denoted by angle θ. The range of motion (angle θ) shown in FIG. 1A results from the flexibility in the thin sections of the actuator 100 relative to the thicker sections, creating a bend along a longitudinal axis of the actuator 100.

A pair of PneuNet actuators 100 can be combined to form a grasping structure, as shown in FIG. 1B. The actuator 100 shown in FIG. 1B is capable of delicate object handling, such as manipulating marine vegetation. FIG. 1C is a schematic with a cross-sectional view of the grasping actuator depicted in FIG. 1B, with the internal cavities 110 of the actuator body 102 shown. FIG. 1C shows additional components, such a conduit 101 which can be connected to a pump for pressure control within the interior chambers 110 and a support structure 130. For the objects shown in FIGS. 1B-1C, when the actuators 100 are pressurized, the structure is in a closed position; when depressurized, the structure is in an opened position.

The actuator 100 is capable of performing under cyclic loading conditions with a range of input flow rates. The actuator 100 can show a swift response (maximum actuation frequency: 1.25 Hz) to input flow rates ranging from 1-8 mL/min and a rise time (time the actuator takes to move from its minimum and maximum bending positions, FIG. 1A) will decrease with higher flow rates. When operated at the maximum frequency (1.25 Hz, flow rate: 8 mL/min) for 500 cycles, the actuator 100 can show a consistent angular deflection motion profile (10.13±0.31°, mean±standard deviation) with only a 2.68% decrease in amplitude across the 500 cycles tested. Similarly, measured pressure changes within each actuation cycle can also show a consistent profile (2.51±0.19 kPa) with a 6.69% drop in pressure range. These results demonstrate the robustness and repeatability of the bending actuator 100.

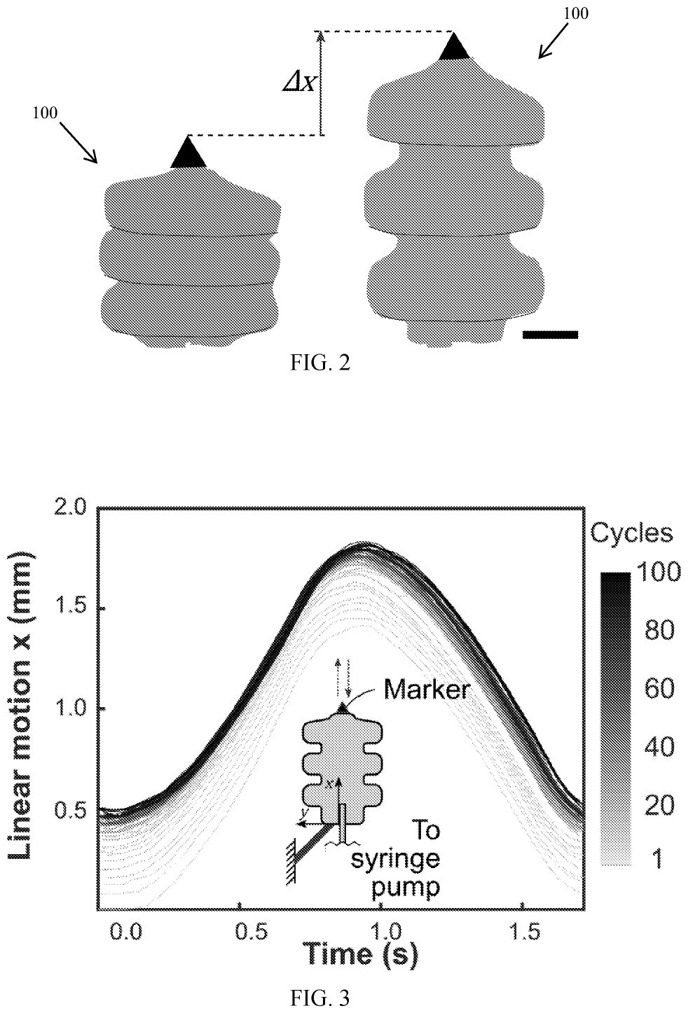

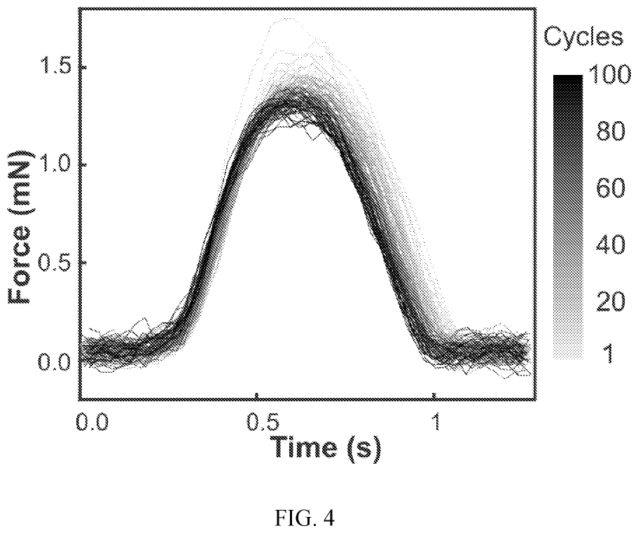

In addition to hydraulic-driven bending actuators 100, the fabrication process can be used to form a linear actuator (FIG. 2), where the movement of the actuator 100 is parallel to the longitudinal axis of the actuator 100. The motion profile for this type of actuator 100 is shown in FIG. 3, where the linear motion in millimeters is tracked against time for up to 100 cycles. The linear actuator 100 shows consistent motion and blocking force profile under cyclic actuation and is robust, remaining functional after more than 100 cycles of actuation. When actuated with a flow rate of 8 mL/min for 100 cycles, the linear actuator 100 demonstrates a consistent linear motion profile (1.34±0.01 mm) with no drop in linear motion amplitude across the 100 cycles tested (FIG. 3). For a linear actuator 100 of the size shown in FIG. 2, the actuator can achieve a minimum and maximum length of 4.92 mm and 8.97 mm, indicating a length expansion of 82.24% from the minimum position. A measured blocking force profile is consistent across 100 cycles (1.40±0.081 mN) (FIG. 4). The results demonstrate that the fabrication technique can be utilized to build millimeter-scale hydrogel actuators 100 with reliable bending and linear motions. These hydraulic actuators 100 also remain functional after hundreds of actuation cycles without structural or operational failure.

Another example actuator 100 includes a twisting continuum actuator, as shown in FIG. 5. This actuator 100 has a body 102 comprising eight bellow units 111 axially arranged with smooth and twisting joints 112. The twisting pattern of the bellows 111 around the central axis, combined with the long aspect ratio, makes this actuator 100 very challenging to fabricate by traditional methods, such as casting, especially when using fragile materials like hydrogels. Upon actuation, these actuators 100 show a composite actuation motion with a large motion range, which is a combination of extension, bending, and twisting. Similar to an elephant's trunk, this actuator 100 can provide compliant grasping when manipulating objects of different sizes by wrapping around them. Additionally, it can transform into a soft hook for handling objects too large for its wrapping motion.

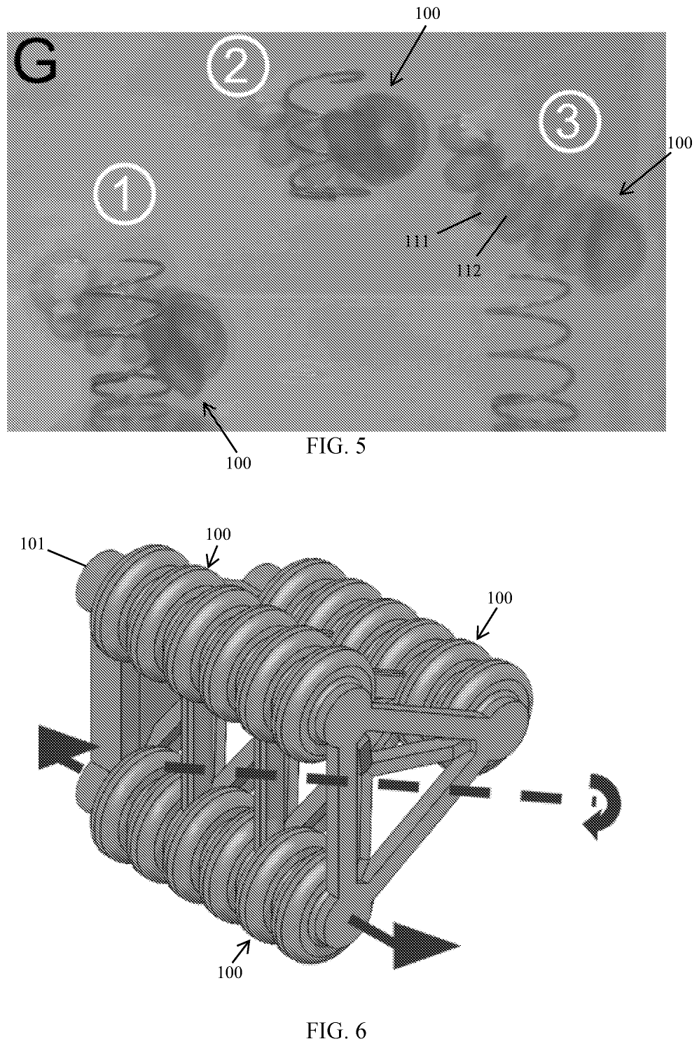

Yet another example actuator 100 is shown in FIG. 6, which is a complex, multi-actuator structure. In this example embodiment, the individual actuators 100 and their supporting structures can be printed simultaneously in the support bath. The structure 100 in FIG. 6 is a three-actuator system with inter-actuator truss supports. Three fluidic channels 101 were inserted into the structural base for each actuator 100. Each channel 101 can be driven independently by a programmatically controlled syringe pump. Actuating each channel 101, either separately or in combination, allows the end effector to be positioned in a 3D workspace. For example, independent control of each actuator 100 in the group allows the structure to move smoothly and position the end in continuous 3D space with high degrees-of-freedom.

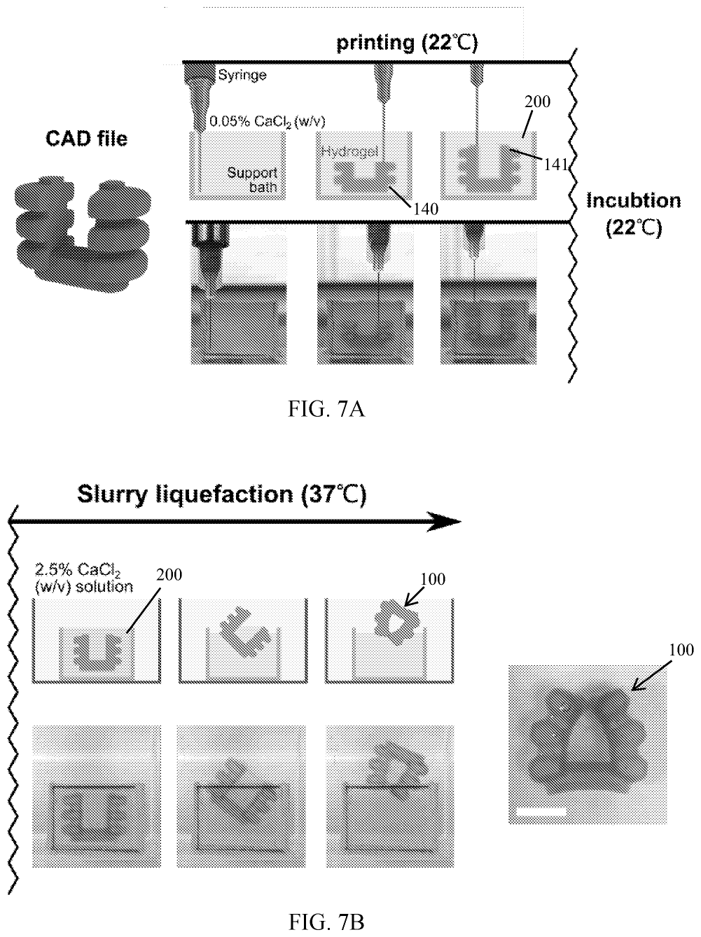

FIG. 7A-7B shows a schematic of the fabrication process, according to one embodiment. First, a drawing file (i.e. computer-aided design file) is created of the desired actuator 100. The drawing file can be used to create instructions for the 3D printer, such as extrusion rate and print orientation. As previously mentioned, forming water-tight structures can be difficult when printing hydrogels. In one embodiment of the printing process (FIG. 7A), the layers of the actuator body 102 are oriented along the longitudinal axis of the body 102. More specifically, the first printed layer 140 is at one end and the last printed layer 141 is at the opposite end of the actuator 100 along its length. Orienting the layers 140/141 in this manner aids the sealing between layers 140/141 when crosslinked.

After creating the drawing file and printing instructions, printing is then performed using alginate bioink in a support bath having a first concentration of a crosslinking initiator 200. In one embodiment, the initiator 200 is a CaCl₂ solution at 0.05% (w/v). The concentration of the initiator 200 can vary depending on the style and size of the actuator 100 and the type of material used in the hydrogel. However, the concentration should be sufficient to allow sealing between adjacent printed layers 140/141, but not so strong that a first layer 140 hardens or fully crosslinks prior to printing of the next layer. After the printing step, the printed actuator 100 is then incubated prior to removing from the support bath. After removal, the actuator 100 is introduced to a second solution having a second concentration of crosslinking initiator 200 (FIG. 7B). In one embodiment, the second concentration is about 2.5% of CaCl₂ used for additional crosslinking, rendering the actuator 100 robust enough for repeated actuation.

The embedded printing technique herein greatly expands geometric design freedom and enables the fabrication of complex 3D actuators 100 that are difficult or impossible to achieve with conventional manufacturing techniques. For example, objects with thin walls and enclosed and irregular internal chambers are difficult to fabricate in one piece using mold casting due to casting-related design constraints, such as minimum wall thickness and the need to remove internal mold components post-casting. A common workaround involves casting different actuator parts before assembling them, which requires additional fabrication steps. The example actuators 100 shown in FIGS. 1A, 1B, 1C and 2 can be fabricated in a single print without requiring multi-part molding or post-printing assembly.

In one example embodiment, alginate is used in the 3D printing ink. The alginate bioink can be prepared by solubilizing sodium alginate in heated deionized water (65° C.) to achieve a concentration of about 4% (w/v). Optionally, to facilitate visualization during printing and imaging, Alcian Blue can be added to the bioink to achieve a concentration of 0.02% (w/v). The gelatin support bath for the printing step is made using a complex coacervation process. Briefly, 50% (v/v) ethanol is made by mixing ethanol with heated deionized water (70-80° C.). 2.0% (w/v) gelatin Type B, 0.25% (w/v) non-ionic surfactant (Pluronic F-127), and 1.0% (w/v) gum arabic are thoroughly mixed in the ethanol solution using magnetic stirring. The gelatin precursor solution is adjusted to 5.550-5.570 pH by adding 1N HCl dropwise using a benchtop PH meter. The precursor solution is stirred overnight using an overhead stirrer in a temperature-controlled room (21-24° C.), and the resulting gelatin slurry is washed three times with 0.05% (w/v) CaCl₂. To prepare the support bath material for printing, the slurry is stirred and centrifuged at 2000 g for 5 minutes prior to printing.

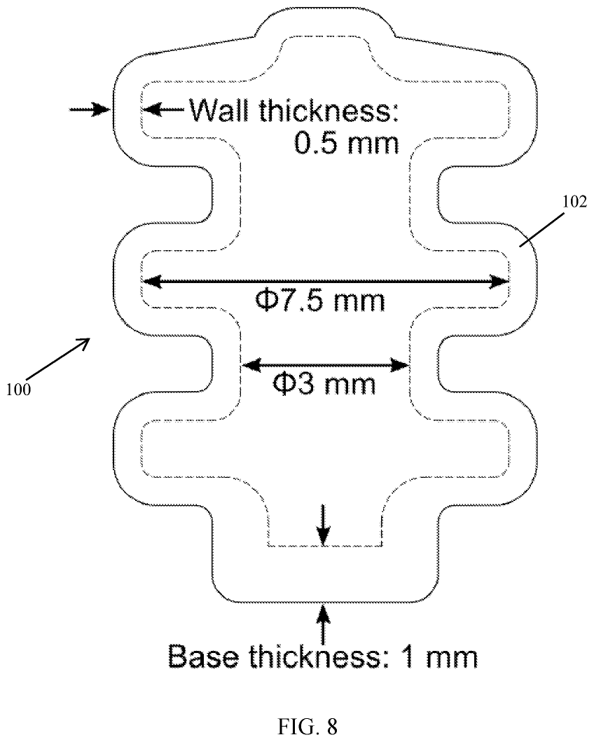

Due to the layer-by-layer, extrusion-based printing method, actuator design and printing strategy affect the water tightness of the actuator 100. For example, PneuNet style actuators 100 are sliced so the bellows can be extruded as continuous filaments in each layer. In bellow regions where the membrane undergoes considerable strain during actuation, the wall thickness setting in the slicer is kept consistent (˜500 μm) to reduce stress concentration and ensure consistent crosslinking. For the actuator wall opposite the bellows, the wall thickness is set to 700 μm in the slicing program. The wall thickness of the remaining flat surfaces is set to 1 mm. The linear actuator 100 embodiment has a circularly-symmetric cross-sectional geometry with a wall thickness of 500 μm (FIG. 8), which allows axial expansion and contraction. During printing, the deposition is designed to progress along the axial direction. Attempts to print the actuators from the transverse direction may fail to produce water tightness. To eliminate unwanted gaps and cavities that might be created by infill patterns, perimeter-only features can be used to create a solid structure throughout the actuator wall during printing strategy generation.

Various types of commercial-off-the-shelf 3D printers can be used. In one example, the printer is a desktop CoreXY 3D printer (Elf, Creativity Technology) equipped with a Replistruder V4 syringe extruder. Before printing, the bioink is transferred to a 5 mL gastight syringe with a G30 blunt-tip needle. For short prints (less than 30 mm), the G30 needle is attached directly to the bioink syringe through a Luer-lock connection. For tall prints, such as multi-actuator structures, the needle length is extended by connecting a G23 needle to the syringe and inserting a G30 needle in the open end of the G23 needle via a press fit. Alginate hydrogel ink is then extruded from the syringe into the CaCl₂ doped gelatin support bath at 22° C. (see FIG. 7A). After printing, the newly deposited hydrogel structure is kept in the original gelatin slurry at room temperature for 20 minutes for 10 mm prints (linear, bending, and gripping actuators 100) and 60 minutes for 30 mm prints (multi-actuator truss system). The printing chamber is then transferred to a water-tight container with 2.5% (w/v) CaCl₂ solution and incubated in a 37° C. water bath for 60 minutes for slurry liquefaction and part retrieval. Subsequently, the printed actuator 100 is transferred to a clean 2.5% (w/v) CaCl₂ solution and incubated for 24 hours at room temperature.

Once printed, chelators can be used to controllably degrade the actuators 100. During printing, newly deposited alginate filaments form highly stable complexes (calcium alginate hydrogels) with the calcium ions in the support bath. Chelators, such as sodium citrate and ethylenediamine tetraacetic acid (EDTA) disodium, can bind to the calcium ions, effectively destabilizing the crosslinked alginate structures and exposing alginate monomers. These newly released alginate monomers can also be re-crosslinked by introducing additional calcium ions.

This reversible chelation-crosslinking mechanism can be exploited to create alginate gripping actuators 100 that could dynamically change shape from the gripper shown in FIG. 1B to a round grabber (FIG. 9). Before chelation, the two fingers of the alginate gripper 100 had normal closing and opening motions upon actuation. During chelation, free alginate monomers become available on the outer surface of the gripper 100 when chelators in the bath bound to the calcium ions from the calcium-alginate complexes. The tips of the two fingers are brought into contact by pressurizing the gripper 100, which forms a temporary connection of alginate monomers. This pressurization-induced connection method can be used among other methods, such as using external manipulators to force the two tips into connection. This temporary alginate monomer bridge can be crosslinked with the introduction of calcium ions and form a stable calcium-alginate complex that bonds the two fingers together.

As a result of this newly introduced structural constraint, when fluid is withdrawn, the gripper 100 contracted instead of opening its two fingers, showing a new actuation geometry (shape morphing) similar to the functionality of a soft robotic grabber 100. The original gripper-styled actuation geometry can be recovered by separating the bonded tips. The chelation-crosslinking induced gripper-grabber shape morphing showcases a unique property of the alginate actuators 100—the ability to switch between different actuation geometries as needed for a given application.

One limiting factor of soft grippers for object handling is the object's size. Items significantly smaller than the finger root distance, such as a thin thread, are more likely to slip through the fingers and cause a loss of grip when compared with those with the same weight and larger sizes. Utilizing the gripper-grabber transformation enabled by the chelation-crosslinking mechanism, the loss of grip and subsequent slip-through of small objects can be eliminated by bonding the two fingers and forming a closed loop.

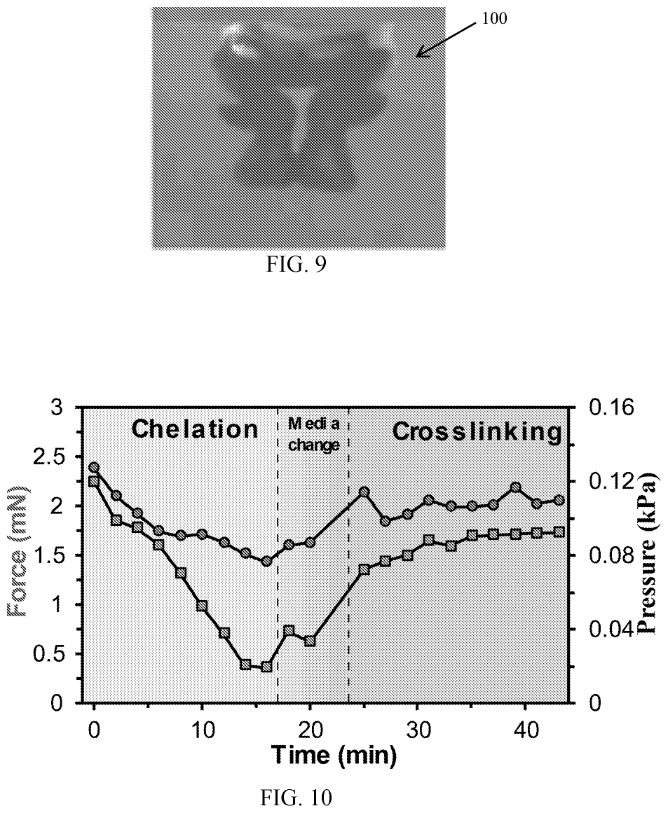

In addition to adding structural constraints or morphing shape post-printing, the reversible chelation-crosslinking mechanism can also modify the stiffness of alginate actuators 100 by changing the degree of calcium crosslinking (see FIG. 10). As the chelation proceeds, the gripper's reaction force and internal pressure decrease, indicating a softening of the calcium-alginate hydrogel structure due to a decreasing degree of crosslinking. In contrast, when additional calcium ions are supplied, both the reaction force and internal pressure increase, indicating a recovery of the rigidity of the alginate structure. This variable degree of crosslinking can be used to fabricate soft components with tunable stiffness and force output capacity that satisfy different operational requirements. For example, the gripper can be softened to handle delicate tissues or organisms.

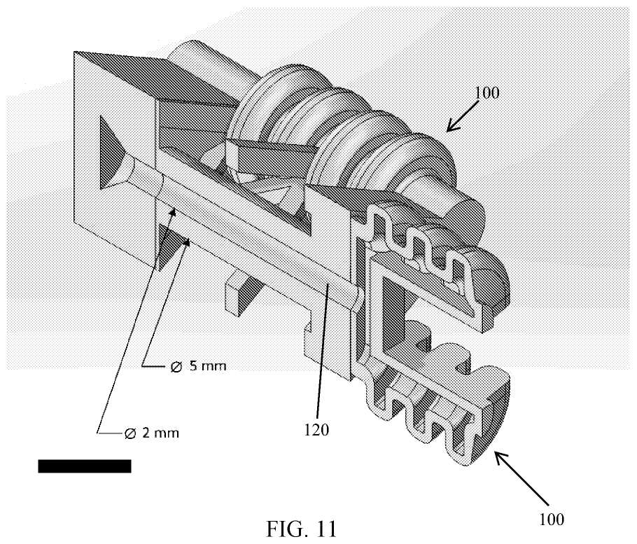

For many hydraulic actuators 100, where fluid is pumped in/out of internal chambers of the actuator 100 to effectuate movement, external tethers to a remote pump are required. A drawback of the tethers is that the drag forces associated with tethered lines can quickly overcome the actuation force of distal and extremity structures. FIG. 11 shows an actuator with an internal fluid conduit 120 to allow working fluid to be channeled to distal components of the soft robots. FIG. 11 is a cross-sectional view of compound structure highlighting a channel 120 enabling hydraulic actuation of distal structures. The internal conduit 120 has a diameter of 2 mm and an outer column diameter of 5 mm. Consideration should also be given to the effect that high pressure flow has on the walls of the surrounding structures to determine if shear stress and pressure are a limiting factor to what can be achieved with channels 120 in alginate actuators 100.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A method of fabricating an actuator for use in a marine environment comprising:
printing a body of the actuator from a biologically-derived hydrogel in a support bath using an additive manufacturing print head,
wherein the support bath has a first concentration of a crosslinking initiator;
incubating the body in a solution having a second concentration of a crosslinking initiator,
wherein the second concentration is greater than the first concentration; and
removing the actuator body from the solution.

2. The method of claim 1, further comprising:
modifying a strength of crosslinking by adding a chelator after removing the actuator body from the solution.

3. The method of claim 2, further comprising:
reversing an effect of the chelator by exposing the actuator body to a calcium solution.

4. The method of claim 1, wherein the crosslinking initiator comprises a CaCl₂ solution and the first concentration is about 0.05%.

5. The method of claim 1, wherein the crosslinking initiator comprises a CaCl₂ solution and the second concentration is about 2.5%.

6. The method of claim 1, further comprising:
preparing the biologically-derived hydrogel by solubilizing sodium alginate in heated deionized water to a concentration of about 4% w/v.

7. The method of claim 1, wherein the body comprises a plurality of layers with a first printed layer and a final printed layer disposed on opposite ends of the body along a longitudinal axis.

8. The method of claim 7, wherein the first concentration is sufficient to allow adjacent layers of the plurality of layers to fuse prior to crosslinking.

9. The method of claim 1, wherein the body of the actuator is printed as a monolithic structure.

10. An actuator suitable for use in a marine environment comprising:
a body defining an internal chamber, wherein the body comprises a plurality of layers of biologically-derived hydrogel aligned along a longitudinal axis of the body; and
a plurality of bonds crosslinking adjacent layers of the plurality of layers to form a water-tight seal.

11. The actuator of claim 10, wherein a shape of the actuator is selected from a group consisting of: a pneumatic network actuator, a linear actuator, a twisting continuum actuator, and a combination of any of the foregoing.

12. The actuator of claim 10 excluding any non-biodegradable materials.

13. The actuator of claim 10, further comprising a pressurized working fluid contained within the internal chamber of the body.

14. The actuator of claim 13, further comprising:
a conduit providing a path for a working fluid from an external source to the internal chamber, wherein the conduit is disposed within an exterior surface of the body.

15. The actuator of claim 10, wherein the biologically-derived hydrogel comprises alginate.
